(19) United States
(12) Patent Application Publication
(10) Pub. No.: US 2015/0345734 A1
(43) Pub. Date: Dec. 3, 2015

(54) OPTICIAL FILM AND LIGHT SOURCE MODULE

(71) Applicant: National Chiao Tung University, Hsinchu City (TW)

(72) Inventors: Yu-Kai Hsu, Hsinchu City (TW); Jui-Wen Pan, Hsinchu City (TW); Che-Wen Chiang, Hsinchu City (TW)

(21) Appl. No.: 14/461,446

(22) Filed: Aug. 18, 2014

(30) Foreign Application Priority Data
May 29, 2014 (TW) 103118786

(51) Int. Cl. F21V 5/00; F21V 5/04; F21V 5/02

(52) U.S. Cl. CPC F21V 5/007; F21V 5/02; F21V 5/04; F21Y 2101/00

(57) ABSTRACT

An optical film adapted to be disposed over a light source is provided. The optical film includes a substrate, a plurality of columnar prismatic units, and a plurality of lenticular lenses. The substrate has a first surface and a second surface, wherein the first surface is located between the second surface and the light source. The columnar prismatic units comprises a plurality of columnar prisms protruding from the first surface or a plurality of prismatic recesses indented in the first surface, and the plurality of columnar prismatic units are arranged along a first direction and respectively extend along a second direction. The lenticular lenses are protruded from the second surface. The lenticular lenses are arranged along the first direction and respectively extend along the second direction. A light source module is also provided.

### CROSS-REFERENCE TO RELATED APPLICATION

This application claims the priority benefit of Taiwan application serial no. 103118786, filed on May 29, 2014. The entirety of the above-mentioned patent application is hereby incorporated by reference herein and made a part of this specification.

### BACKGROUND OF THE INVENTION

1. Field of the Invention

The disclosure generally relates to an optical film and a light source module, and, more particularly, to an optical film that improves the luminance uniformity of a light source and a light source module applying the optical film.

2. Description of Related Art

Because of its desirable qualities of a fast reaction rate, compactness, power conserving, low pollution, high reliability, and suitability for mass production, a light emitting diode (LED) has been widely used in the field of illumination and back light source. However, since a light emitting diode is similar to a point light source, LEDs serving as a light source of a direct-type light source module may generate the hot spot phenomenon and ghost image phenomenon due to non-uniform luminance; consequently, discomfort to the viewer is resulted.

Conventionally, a diffuser is applied to improve luminance uniformity. However, the disposition of a diffuser tends to drastically lower the light emitting efficiency. Improving the luminance uniformity while precluding a drastic drop in the light emitting efficiency is being actively pursued in the industry.

### SUMMARY OF THE INVENTION

An exemplary embodiment of the disclosure discloses an optical film, wherein uniform luminance of the light source is achieved without significantly compromising the light emitting efficiency.

An exemplary embodiment of the disclosure discloses a light source module wherein a plane light source with high luminance and high uniformity is provided.

An optical film of an exemplary embodiment of the disclosure is disposed over a light source. The optical film includes a substrate, a plurality of columnar prismatic units and a plurality of lenticular lenses. The substrate includes a first surface and a second surface, wherein the first surface is positioned between the second surface and the light source. The columnar prismatic units comprises a plurality of columnar prisms protruding from the first surface or a plurality of prismatic recesses indented in the first surface, and the plurality of columnar prismatic units are arranged along a first direction and respectively extend along a second direction. The lenticular lenses protrude from the second surface. The lenticular lenses are arranged along the first direction and respectively extend along the second direction.

According to an exemplary embodiment of the disclosure, the width of each columnar prismatic unit in the first direction is between 60 μm to 80 μm, while the bottom angles of each columnar prismatic unit respectively fall in the range of 45° to 65°.

According to an exemplary embodiment of the disclosure, the width of each lenticular lens in the first direction is W, wherein W falls in the range of 60 μm to 80 μm, while the height, which is perpendicular to the first surface in the third direction, of each lenticular lens is in the range of 0.2W to 0.5W.

According to an exemplary embodiment of the disclosure, the orthogonal projection of the columnar prismatic units on the second surface completely overlaps with the orthogonal projection of the lenticular lenses on the second surface.

According to an exemplary embodiment of the disclosure, the orthogonal projection of the columnar prismatic units on the second surface partially overlaps with the orthogonal projection of the lenticular lenses on the second surface.

An exemplary embodiment of the disclosure discloses a light source module including a light source and the above optical film.

According to an exemplary embodiment of the disclosure, light splitting is achieved through the disposition of the columnar prismatic units and uniform luminance is further achieved through the disposition of the lenticular lenses. Accordingly, uniform luminance is achieved without significantly compromising the light emitting efficiency, and the application of the light source module with the optical film of the exemplary embodiment of the disclosure provides a plane light source with high luminance and high uniformity.

The disclosure and certain merits provided by the application can be better understood by way of the following exemplary embodiments and the accompanying drawings, which are not to be construed as limiting the scope of the disclosure.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded view diagram of a light source module according an exemplary embodiment of the disclosure.

FIG. 2 is a magnified view of a part of the optical film in FIG. 1.

FIG. 3 is a magnified view of a part of the optical film in FIG. 1 according to another exemplary embodiment of the disclosure.

### DESCRIPTION OF THE EMBODIMENTS

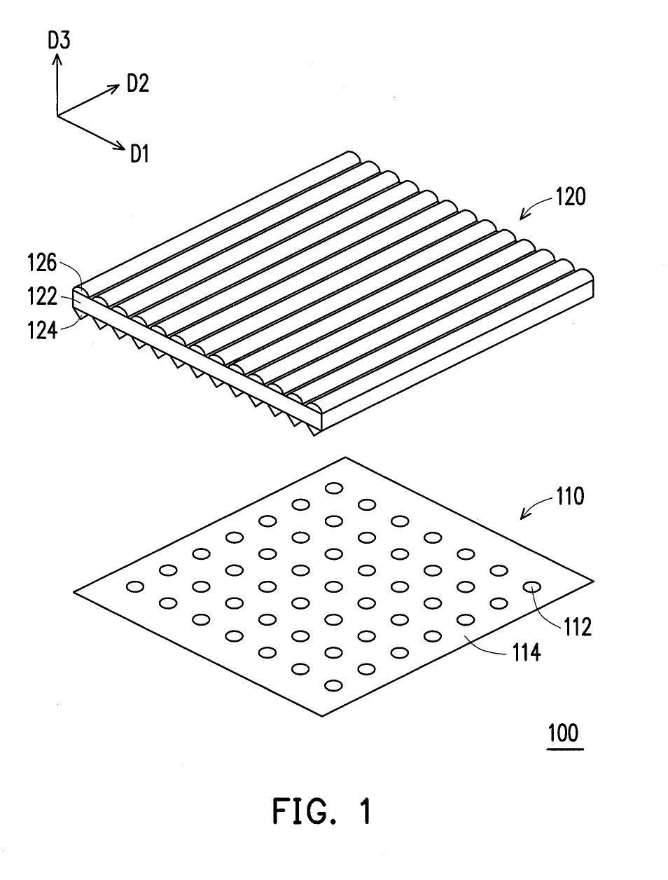

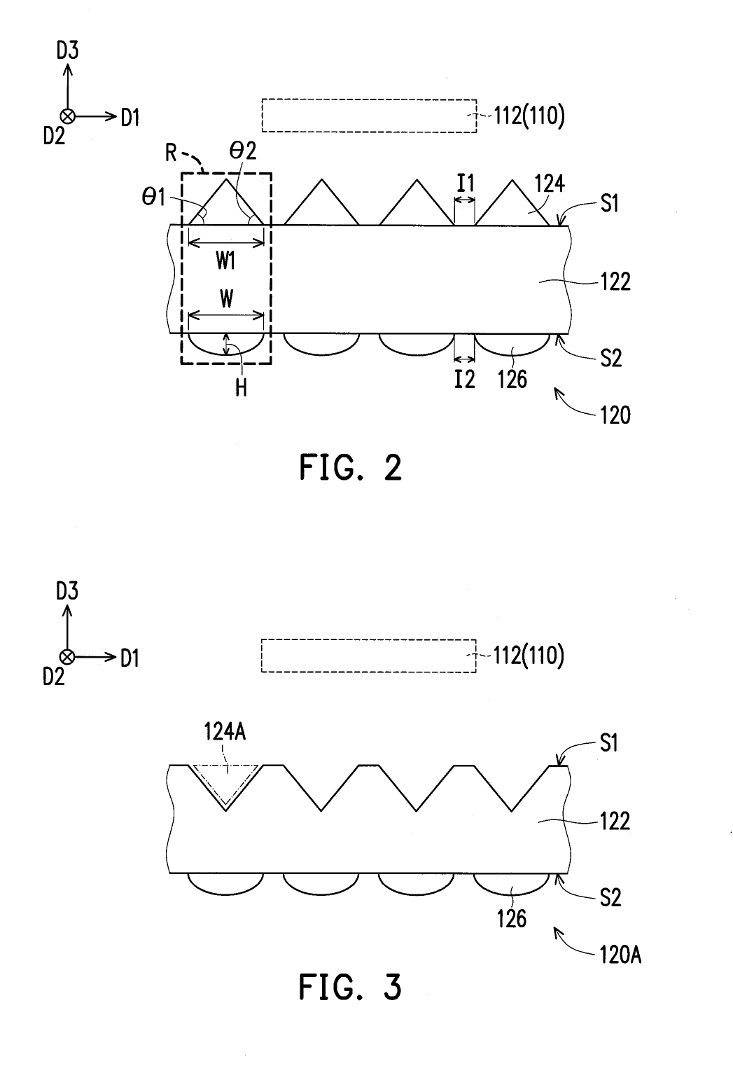

FIG. 1 is an exploded view diagram of a light source module according an exemplary embodiment of the disclosure. FIG. 2 is a magnified view of a part of the optical film in FIG. 1. Referring to both FIGS. 1 and 2, the light source module 100 includes a light source 110 and an optical film 120.

The light source 110 includes, for example, a plurality of light emitting diodes 112 and a circuit board 114, wherein the light emitting diodes 112 are disposed on the side of the circuit board 114 that is closer to the optical film 120, and each light emitting diode 112 is adapted to emit a light beam toward the optical film 120.

Since each light emitting diode 120 is similar to a point light source, the light beam emitted from the light emitting diode 112, which is being emitted directly from the light source module 100, easily generates the hot spot phenomenon because of non-uniform luminance. Further, when the same object is illuminated by the light emitting diodes 112 configured at different positions, a plurality of stacked shadow s (ghost image phenomenon) are generated below the illuminated object; the resolution ratio of the human eye is thereby lowered. Whether it is the hot spot phenomenon or the ghost image phenomenon, discomfort to viewer is resulted. In this exemplary embodiment of the disclosure, the optical film 120 is disposed over the light source 110 (for example, between the light source 110 and the viewer) for transforming the light beam from each light emitting diode 112 to a uniform plane light source; hence, the sense of discomfort due to the non-uniform luminosity of the light source is mitigated.

More specifically, the optical film 120 includes a substrate 122, a plurality of columnar prismatic units 124 and a plurality of lenticular lenses 126, wherein the substrate 122, the columnar prismatic units 124 and the lenticular lenses 126 are formed by ejection molding simultaneously; alternatively, at least one of the substrate 122, the columnar prismatic units 124 and the lenticular lenses 126 are independently fabricated, followed by adhering to the substrate 122 via an adhesive layer. The material of the optical film 120 includes, but is not limited to, polymer.

The substrate 122 includes a first surface S1 and a second surface S2, wherein the first surface Si is positioned between the second surface S2 and the light source 110. The columnar prismatic units 124 in this exemplary embodiment comprises a plurality of columnar prisms protruding from the first surface Si and are arranged along the first direction D1 and respectively extend in the second direction D2. The first direction D1 intersects with the second direction D2; for example, D1 is perpendicular to D2; however, it should be understood that the above embodiment is presented by way of example and not by way of limitation. Moreover, the lenticular lenses 126 are protruded from the second surface S2 and are arranged along the first direction D1 and respectively extend in the second direction D2.

In this exemplary embodiment, the width W1 of each columnar prismatic unit 124 in the first direction D1 is between about 60 μm and 80 μm, and the bottom angles θ1 and θ2 respectively fall in the range of 45° to 65°. In another exemplary embodiment, the bottom angles θ1 and θ2 respectively fall in the range of 53° to 55°. For example, the shape of the cross-sectional area of each of the plurality of columnar prismatic unit 124 on a reference plane R (the D1-D3 plane) is an isosceles triangle.

Further, the width W of each lenticular lens 126 in the first direction D1 falls in the range of 60 μm and 80 μm, and the height H, that is perpendicular to the first surface S1 in the third direction D3, of each lenticular lens 126 may be adjusted according to the bottom angles θ1 and θ2 of each lenticular lens 126. In this exemplary embodiment, the height H of each lenticular lens 126 falls in the range of 0.2W to 0.5W.

In another exemplary embodiment, the height H of each lenticular lens 126 is about 0.5W. For example, the shape of the cross-sectional area of each lenticular lens 126 on the reference plane R is a half circle or an arc.

In this exemplary embodiment, the width W1 of each columnar prismatic unit 124 in the first direction D1 is equal to the width W of each lenticular lens 126 in the first direction D1. Further, the orthogonal projection of the columnar prismatic units 124 on the second surface S2 completely overlaps with the orthogonal projection of the lenticular lenses 126 on the second surface. Stated differently, the lenticular lens 126 and the columnar prismatic units 124 are aligned with each other in the third direction D3. However, the ratio of the width of the columnar prismatic unit 124 to that of the lenticular lens 126 and the overlapping ratio of the columnar prismatic unit 124 to that of the lenticular lens 126 are not particularly limited in the disclosure. For example, in another exemplary embodiment, the orthogonal projection of the columnar prismatic units 124 on the second surface S2 may partially overlap with the orthogonal projection of the lenticular lenses 126 on the second surface S2. Alternatively speaking, lenticular lenses 126 may be disposed at a distance relative to the columnar prismatic units 124 such that the columnar prismatic units 124 and the lenticular lenses 126 are alternately configured in the third direction D3.

Further, there is a distance I1 between two neighboring columnar prismatic units 124 and there is a distance 12 between two neighboring lenticular lenses 126. In this exemplary embodiment, the distance I1 is smaller than the width W1 of each columnar prismatic unit 124 but is not equal to zero, while the distance 12 is smaller than the width W of each lenticular lens 126 but is not equal to zero. However, it should be understood that the above embodiment is presented by way of example and not by way of limitation. In another exemplary embodiment, at least one of the distance I1 and the distance 12 may equal to zero.

The light beams from the light source 110, after sequentially travel through the columnar prismatic units 124 and the lenticular lenses 126, are emitted from the light source module 100, wherein the point light sources of the light emitting diodes 122 are diffused by the columnar prismatic units 124 in the direction parallel to the first direction D1, and the diffused light beams are further diffused by the lenticular lenses 126 in the direction parallel to the first direction D1 to reduce the luminance difference between the region that is disposed with the light emitting diodes 112 and the region at which the light emitting diodes 112 are absent. Accordingly, a relatively uniform plane light source is formed. Comparing with the conventional approach of applying a diffuser for diffusing the light beams from a light source to achieve the uniformity effect, the application of the optical film 120 of the exemplary embodiments of the disclosure mitigates power loss resulted from scattering, and uniform luminance is achieved without significantly compromising the light emitting efficiency. Accordingly, the application of the optical film 120 of the exemplary embodiments of the disclosure in the light source module 100 provides a plane light source with high luminance and high uniformity.

In the exemplary embodiment as shown in FIG. 1, according to the different design requirements, the light source module 100 may be further disposed a secondary optics on each light emitting diode 112 to adjust the light shape and the effect of uniform luminosity.

FIG. 3 is a magnified view of a part of the optical film in FIG. 1 according to another exemplary embodiment of the disclosure. Referring to FIG. 3, the optical film 120A of this exemplary embodiment is substantially the same as the optical film 120 in FIG. 2, and the same reference numbers are used to refer to the same or like parts and repetitive descriptions are omitted hereinafter. The main difference between the optical film 120A and the optical film 120 lies in that the columnar prismatic units 124A include a plurality of prismatic recesses indented in the first surface S1 to function as prisms.

In this exemplary embodiment, the point light sources of the light emitting diodes 122 are diffused by the columnar prismatic units 124A in the direction parallel to the first direction D1, and the diffused light beams are further diffused by the lenticular lenses 126 in the direction parallel to the first direction D1 to form a relatively uniform plane light source. Comparing with the conventional approach of applying a diffuser to diffuse the light beams from a light source to achieve uniform luminance, the application of the optical film 120A of the exemplary embodiments of the disclosure can achieve uniform luminance without significantly compromising the light emitting efficiency. Accordingly, the application of the optical film 120A of the exemplary embodiment of the disclosure in the light source module provides a plane light source with high luminance and high uniformity.

According to the exemplary embodiment of the disclosure, light splitting is achieved through the disposition of the columnar prismatic units and further luminous uniformity is achieved through the disposition of the lenticular lenses. Accordingly, uniform luminance is achieved without significantly compromising the light emitting efficiency, and the application of the light source module with the optical film of the exemplary embodiment of the disclosure provides a plane light source with high luminance and high uniformity.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An optical film, disposed over a light source, the optical film comprising:
a substrate, comprising a first surface and a second surface, wherein the first surface is positioned between the second surface and the light source;
a plurality of columnar prismatic units, comprising a plurality of columnar prisms protruding from the first surface or a plurality of prismatic recesses indented in the first surface, and the plurality of columnar prismatic units are arranged along a first direction and respectively extend along a second direction; and
a plurality of lenticular lenses, protruding from the second surface, and the plurality of lenticular lenses are arranged along the first direction and respectively extend along the second direction.

2. The optical film of claim 1, wherein a width of each columnar prismatic units of the plurality of columnar prismatic units in the first direction is between 60 μm and 80 μm, while bottom angles of the each columnar prismatic unit of the plurality of columnar prismatic units are respectively between 45° to 65°.

3. The optical film of claim 1, wherein a width of each lenticular lens of the plurality of lenticular lenses in the first direction is W and is between 60 μm and 80 μm, and a height, which is perpendicular to the first surface in a third direction, of each lenticular lens of the plurality of lenticular lenses is between 0.2W and 0.5W.

4. The optical film of claim 1, wherein an orthogonal projection of the plurality of columnar prismatic units on the second surface completely overlaps with an orthogonal projection of the plurality of lenticular lenses on the second surface.

5. The optical film of claim 1, an orthogonal projection of the plurality of columnar prismatic units on the second surface partially overlaps with an orthogonal projection of the plurality of lenticular lenses on the second surface.

6. A light source module, comprising:
a light source; and
an optical film, disposed over the light source, the optical film comprising:
a substrate, comprising a first surface and a second surface, wherein the first surface is positioned between the second surface and the light source;
a plurality of columnar prismatic units, comprising a plurality of columnar prisms protruding from the first surface or a plurality of prismatic recesses indented in the first surface, and the plurality of columnar prismatic units are arranged along a first direction and respectively extend along a second direction; and
a plurality of lenticular lenses, protruding from the second surface, and the plurality of lenticular lenses are arranged along the first direction and respectively extend along the second direction.

7. The light source module of claim 6, wherein a width of each columnar prismatic units of the plurality of columnar prismatic units in the first direction is between 60 μm and 80 μm, while bottom angles of the each columnar prismatic units of the plurality of columnar prismatic units are respectively between 45° to 65°.

8. The light source module of claim 6, wherein a width of each lenticular lens of the plurality of lenticular in the first direction is W and is between 60 μm to 80 μm, and a height, which is perpendicular to the first surface in a third direction, of each lenticular lens of the plurality of lenticular lenses is between 0.2W and 0.5W.

9. The light source module of claim 6, wherein an orthogonal projection of the plurality of columnar prismatic units on the second surface completely overlaps with an orthogonal projection of the plurality of lenticular lenses on the second surface.

10. The light source module of claim 6, wherein an orthogonal projection of the plurality of columnar prismatic units on the second surface partially overlaps with an orthogonal projection of the plurality of lenticular lenses on the second surface.
